(19) United States
(12) Patent Application Publication
(10) Pub. No.: US 2025/0069302 A1
(43) Pub. Date: Feb. 27, 2025

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: KENTO MANNEN, Kanagawa (JP)

(21) Appl. No.: 18/776,492

(22) Filed: Jul. 18, 2024

(30) Foreign Application Priority Data
Aug. 24, 2023 (JP) 2023-136358

(51) Int. Cl. G06T 11/60; G06T 7/90

(52) U.S. Cl. CPC G06T 11/60; G06T 7/90; G06T 2200/24

(57) ABSTRACT

An information processing apparatus has: an editing unit configured to edit layout data including at least one image slot in which an image is arranged; a reception unit configured to receive an operation of selecting a template including at least one image slot in which an image is arranged, during editing of the layout data; an obtaining unit configured to obtain template information of the selected template; and a determination unit configured to determine an image to be arranged in the image slot included in the selected template, from the image arranged in the currently-edited layout data, based on predetermined information relating to the currently-edited layout data and the template information.

### BACKGROUND

### Field

The present disclosure relates to an information processing apparatus, a method of controlling an information processing apparatus, and a storage medium.

### Description of the Related Art

There has been conventionally known a method in which characters and image data that one likes is printed by using a template in which a layout is determined in advance, and data is applied to the template to produce the layout data. For example, predetermined layout data editing application software is released to implement print layout processing.

In the case where a template is selected during editing of the layout data, the predetermined layout editing application deletes the currently-edited layout data, and applies information on the selected template to layout data to be newly edited.

Accordingly, the user needs to reproduce the contents of editing before the template selection according to the layout of the template applied to the new layout data, and this leads to a decrease in usability. To counter this problem, a method in which the images used by the user are arranged in poster data after the template change according to a predetermined order is generally conceivable.

Moreover, Japanese Patent Laid-Open No. 2022-067587 (hereinafter, referred to as Literature 1) describes a technique in which image data of new translated document and image data of old translated document are associated with each other, and the image data of old translated document is updated all at once based on the information indicating the association.

### SUMMARY

However, in Literature 1 and the method in which the images used by the user are arranged in the poster data after the template change in a predetermined order, the layout data after the template change sometimes becomes layout data not intended by the user.

In view of the above circumstances, an object of the present disclosure is to improve usability of the layout data editing application.

A storage medium storing a program according to one aspect of the present disclosure is a program which functions in an information processing apparatus and causes the information processing apparatus to function as: an editing unit configured to edit layout data including at least one image slot in which an image is arranged; a reception unit configured to receive an operation of selecting a template including at least one image slot in which an image is arranged, during editing of the layout data; an obtaining unit configured to obtain template information of the selected template; and a determination unit configured to determine an image to be arranged in the image slot included in the selected template, from the image arranged in the currently-edited layout data, based on predetermined information relating to the currently-edited layout data and the template information.

Further features of the present invention will become apparent from the following description of exemplary embodiments with reference to the attached drawings.

### BRIEF DESCRIPTION OF THE DRAWINGS

FIG. 1 is a diagram illustrating a configuration of an information processing apparatus;

FIG. 2 is a diagram illustrating a configuration of a system;

FIG. 3 is a diagram illustrating an editing screen of a poster producing application;

FIG. 4 is a diagram illustrating a template;

FIGS. 5A to 5C are an example of poster data in a template change;

FIGS. 6A and 6B are diagrams of template configuration examples;

FIG. 7 is a flowchart of a process of template change;

FIG. 8 is a diagram illustrating an example of a screen configuration in which image arrangement pattern candidates are displayed; and

FIG. 9 is a flowchart of a process of template change.

### DESCRIPTION OF THE EMBODIMENTS

Embodiments are explained below in detail with reference to the attached drawings. Note that the following embodiments do not limit the invention according to the scope of claims. Moreover, although multiple characteristics are described in the embodiments, not all of these multiple characteristics are necessarily essential for the invention, and the multiple characteristics can be used in any combination. In the attached drawings, the same or similar configurations are denoted by the same reference numerals, and overlapping explanation is omitted.

### Embodiment 1

### <System Configuration>

An information processing apparatus to which the present embodiment is applied is explained. Although a personal computer (PC) can be given as an example of the information processing apparatus, the information processing apparatus may be any apparatus that can perform display and editing operations of texts and in which a program can operate. The present embodiment can be applied to, for example, a mobile terminal, a laptop computer, a tablet terminal, a personal digital assistant (PDA), and the like.

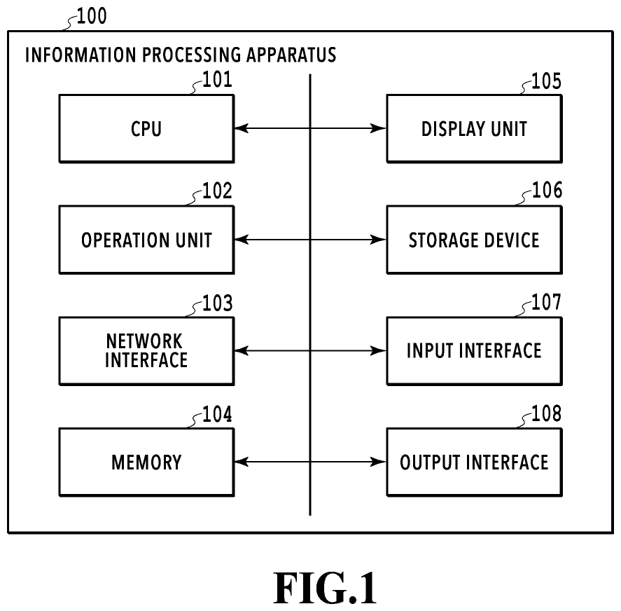

FIG. 1 is a diagram illustrating a hardware configuration of the information processing apparatus 100 in the present embodiment. The information processing apparatus 100 includes a CPU 101, an operation unit 102, a network interface 103, a memory 104, a display unit 105, a storage device 106, an input interface 107, and an output interface 108. Moreover, these components are connected to one another via a system bus.

The CPU 101 controls the entire information processing apparatus 100. The operation unit 102 is an operation unit used by a user to give instructions to the information processing apparatus 100, and includes, for example, a button, a touch panel, or the like. Note that, although FIG. 1 illustrates an example of the case where the operation unit 102 is embedded in the information processing apparatus 100, the information processing apparatus 100 may be operated from an external keyboard or the like by connecting the external keyboard or the like to the input interface 107.

The network interface 103 is an interface for connection with a network. The information processing apparatus 100 is configured to be connectable to the network via the network interface 103 and connectable to the Internet via the network.

The memory 104 is a random-access memory (RAM) that functions as a work area of the CPU 101. The memory 104 is used as a temporary storage area of various pieces of received data, and stores various pieces of setting data.

The display unit 105 is a unit that displays various pieces of information, and is formed a liquid crystal panel or the like. Note that, although FIG. 1 illustrates an example of the case where the display unit 105 is embedded in the information processing apparatus 100, the configuration may be such that an external display device is connected to the output interface 108 and the pieces of information are displayed on the external display device.

The storage device 106 is, for example, a flash memory or the like, and stores various control programs such as applications and an operating system (hereinafter, referred to as OS) and various pieces information used by these programs.

The input interface 107 is an interface for receiving data inputs and operation instructions from the user. The input interface 107 is formed of, for example, a physical keyboard, buttons, a touch panel, and the like. Note that the input interface 107 and the output interface 108 to be described later may be integrated such that output of images and reception of operations from the user are performed by using common hardware.

The output interface 108 is an interface that performs control for displaying data and presenting information on a status of the information processing apparatus 100 on the external display device or the like. For example, the output interface 108 outputs control information and display target information for displaying information on the external display device. The external display device is configured to include a light emitting diode (LED), a liquid crystal display (LCD), or the like, and displays data or notifies the user of the status of the information processing apparatus 100. Note that the configuration may be such that a software keyboard including keys such as numeral input keys, a mode setting key, a determination key, a cancel key, and a power supply key is displayed on the external display device, and the information processing apparatus 100 receives inputs from the user via the software keyboard.

### <Poster Producing Application>

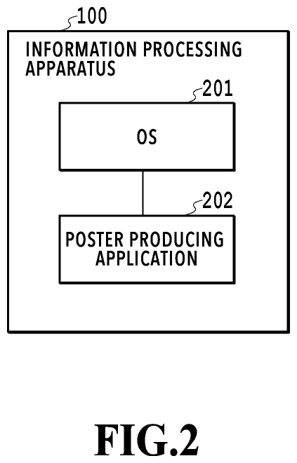

FIG. 2 is a diagram illustrating a functional configuration example of the information processing apparatus 100. The information processing apparatus 100 includes, for example, an OS 201 and a poster producing application 202 that executes processes to be described later, as functional configurations. In a screen of the poster producing application 202 operating on the OS 201, the user produces poster data. The produced poster data may be, for example, posted on a home page or a social networking service (SNS), or printed by connecting a printing apparatus to the information processing apparatus 100. Moreover, although the poster producing application 202 is included in the information processing apparatus 100 in the present embodiment, the poster producing application 202 may take a form of, for example, a web application.

Next, an example of a flow of a production operation by the poster producing application 202 is explained.

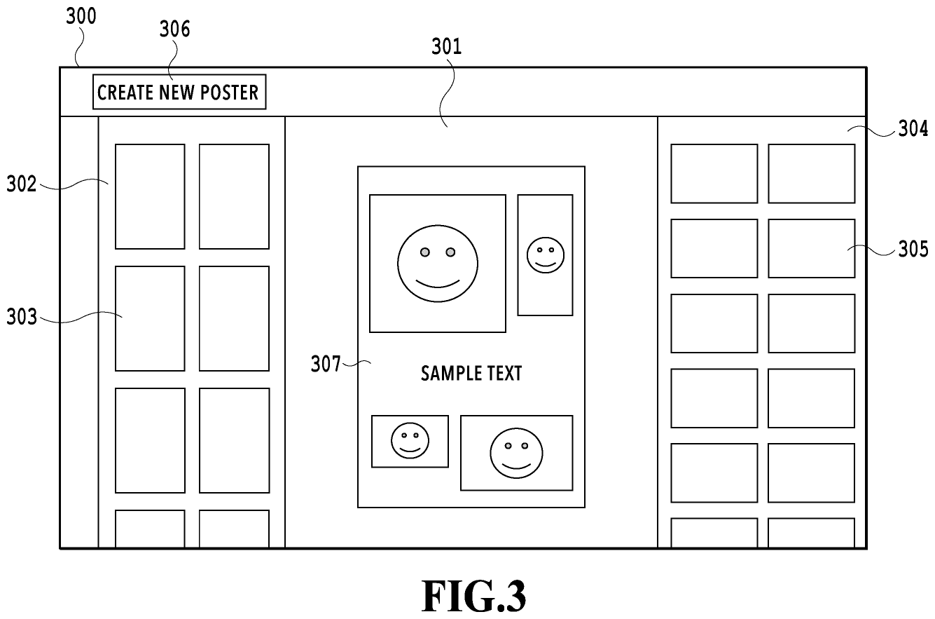

FIG. 3 illustrates an example of a poster editing screen displayed on the display unit 105 in the case where the CPU 101 of the information processing apparatus 100 executes a program corresponding to the poster producing application 202 stored in, for example, the memory 104 or the storage device 106. The editing screen 300 includes, as an example, a poster preview region 301, a template selection region 302, templates 303, an image selection region 304, images 305, and a new poster creation button 306.

A preview of the poster data 307 is displayed in the poster preview region 301, and the user checks and changes the layout of the poster in the poster preview region 301. The templates 303 with designs varying from one another are displayed in the template selection region 302. Selecting one of the templates 303 causes the selected template to be displayed in the poster preview region. The user can not only create the poster data 307 by selecting a template but can also create a poster from a blank paper by pressing the new poster creation button 306. The images 305 varying from one another are displayed in the image selection region 304. Selecting one of the images 305 adds the selected image to the poster data 307.

### <Template Changing Process>

In the present embodiment, explanation is given of a method of assigning the images arranged in the poster data to image slots included in the poster data after a template change in the case where the user selects a template during editing of the poster data.

Conventionally, in the case where the template is changed to another template during editing of the poster data, the images to be initially arranged in the image slots in the template after the change are selected from the images arranged in the poster data before the change according to a predetermined order. Accordingly, the arrangement is sometimes different from the image arrangement intended by the user, and the user has to execute an operation of performing image arrangement multiple times including image arrangement to the poster data before the change.

Accordingly, explanation is given below of a method of performing control for bringing the arrangement of the initially-arranged images in the template after the change closer to the arrangement intended by the user.

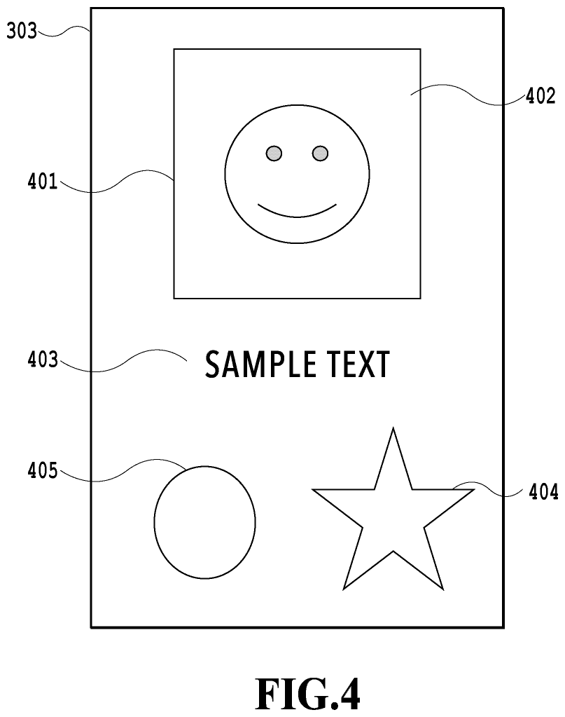

FIG. 4 is an example of the template, and the template includes at least one image slot 401. The image slot 401 indicates a region in which an image 402 can be arranged, and the image 402 in the image slot 401 can be changed by selecting one of the images 305 in the image selection region 304. The shape of the image slot 401 is not limited, and may be clipped to a predetermined shape. Although a default image is set in the image slot 401 in many cases, no default image may be set. Moreover, the template may include, in addition to the image slot 401, a text 403 expressing character string data, a clip art 404 expressed by a vector image, a FIG. 405, and the like.

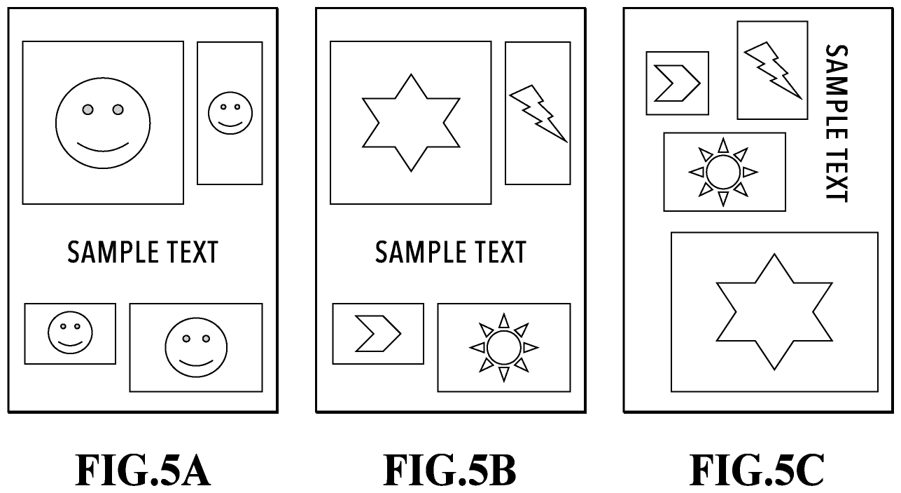

FIGS. 5A to 5C are an example of changes of the poster data. Screen display in the case where the poster data created from a template A is changed to a template B in the present embodiment is explained by using FIGS. 5A to 5C.

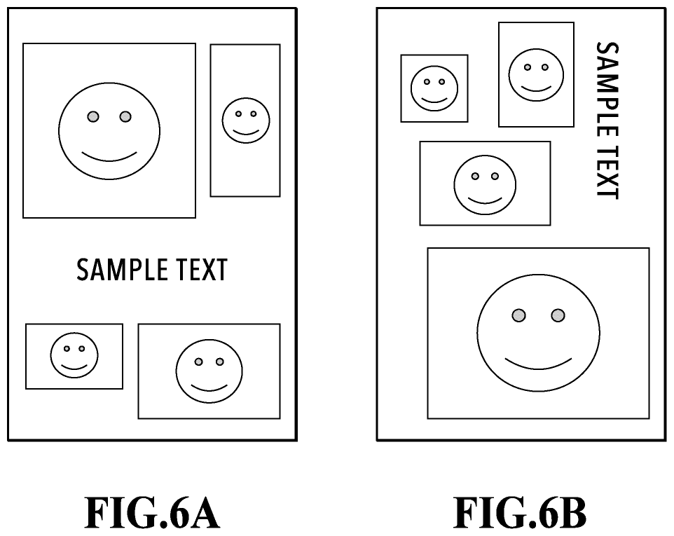

FIGS. 6A and 6B are configuration examples of the template A and the template B. FIG. 5A is a state in the case where the poster producing application 202 develops the template A on the poster data 307 in response to selection of the template A from the template selection region 302 by the user. The user changes an image in each image slot in FIG. 5A to an arbitrary image from this state. FIG. 5B is an example of the poster data in the case where the user has changed the image in each image slot in FIG. 5A to the arbitrary image. Next, in the case where the user desires to change the layout to the layout of the template B, the user selects the template B from the template selection region 302. The poster producing application 202 develops the template B on the poster data 307 in response to the selection of the template B from the template selection region 302 by the user. In this case, images in image slots of the template B are replaced by the images used in FIG. 5B. FIG. 5C is an example of the poster data 307 eventually displayed on the screen.

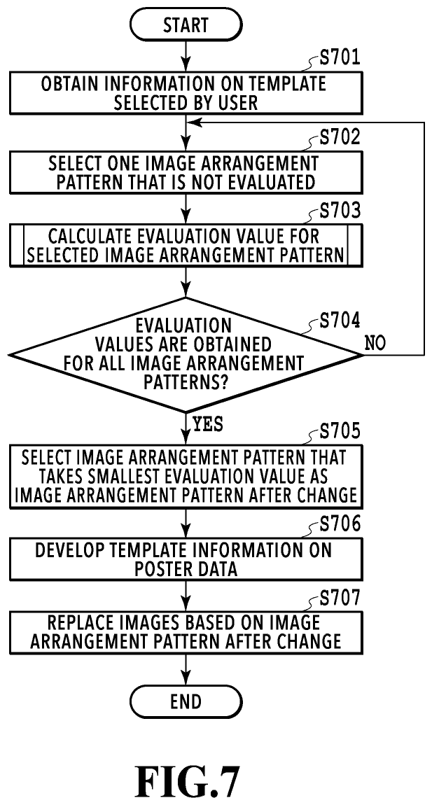

Next, the present embodiment is explained by using the flowchart of FIG. 7. FIG. 7 is a processing flow of the poster producing application 202 operating on the OS 201. The present flowchart is a flowchart illustrating processes in the case where the user selects the template 303 other than the currently-edited template from the template selection region 302 while editing the poster data by using the poster producing application 202.

The CPU 101 of the information processing apparatus 100 implements the processes of the present flowchart by loading and executing the program corresponding to the poster producing application 202 stored in the memory 104 or the storage device 106. Moreover, the processes of the present flowchart are started in the case where the user selects an arbitrary template 303 from the template selection region 302 while editing the poster data. Hereinafter, explanation is given assuming that a subject of the flowchart is the poster producing application 202 controlled by the CPU 101 of the information processing apparatus 100. Note that the symbol “S” in the explanation of each process of the present flowchart means step in the flowchart, and the same applies to the drawings described hereinafter.

In S701, the poster producing application 202 obtains template information of the template 303 selected from the template selection region 302 by the user. The template information is information on the images set by default, the shapes of the image slots, or the like in the template. The template information may be saved in advance in the storage device 106 or obtained from an external server through the network interface 103. In the case where n images are to be arranged in m image slots included in the template, there are nPm possible image arrangement patterns. In this case, n≥m. In the case where n<m, n image slots are selected from the m image slots, and the n images are arranged in the selected image slots without duplication. Accordingly, there are mPn possible image arrangement patterns.

In S702, the poster producing application 202 selects one image arrangement pattern from the above-mentioned possible image arrangement patterns. In this case, a condition of the image arrangement pattern to be selected by the poster producing application 202 is such that an image arrangement pattern for which an evaluation value is not obtained is selected. The evaluation value of the image arrangement pattern is a value obtained in S703 to be described later. It can be determined such that the lower the evaluation value of the image arrangement pattern is, the higher the similarity with the default image arrangement pattern after the change is. Performing image arrangement assumed to have high similarly can increase a possibility that the images desired by the user are arranged at desired positions from the edit start stage.

In S703, the poster producing application 202 calculates the evaluation value for the image arrangement pattern selected in S702. A method of calculating the evaluation value is described later. In S704, the poster producing application 202 determines whether the evaluation values are obtained for all possible image arrangement patterns.

In S704, the poster producing application 202 determines whether the evaluation values are obtained for all image arrangement patterns. In the case where the poster producing application 202 determines that the evaluation values of all image arrangement patterns are obtained, the poster producing application 202 proceeds to S705. Meanwhile, in the case where the poster producing application 202 determines that not all evaluation values are obtained, the poster producing application 202 returns to S702.

In S705, the poster producing application 202 selects the image arrangement pattern that takes the smallest evaluation value among the evaluation values obtained in S702 to S704, as the image arrangement pattern after the change. In S706, the poster producing application 202 develops the information on the template obtained in S701 on the poster data. Specifically, the poster producing application 202 changes the current template in the poster data to the template 303 selected by the user in S701. In S707, the poster producing application 202 performs a process of replacing the images based on the image arrangement pattern selected in S705, on the poster data after the template change. Specifically, the poster producing application 202 determines (specifies) the images to be arranged in the image slots included in the selected template, from the images arranged in the currently-edited layout data. After completion of S707, the poster producing application 202 terminates the process of the present flowchart.

Note that, although the present embodiment is explained assuming that the poster data is being edited, a method in which the user starts editing of the poster data is not limited. A typical editing method of the poster data includes a method of selecting the template 303 from the template selection region 302 and replacing the images in the image slot 401 included in the template. Moreover, an automatic design function in which multiple layouts are generated from the text or the image designated by the user may be used. The automatic design function is a function of performing a process of fitting the text or the image designated by the user to each template and presenting layouts that are attractive to the user. Moreover, although the user arranges the desired images to the image slots existing in the template in the editing method of the poster data described above, the user may add an arbitrary image. In this case, the idea of the replaced image arrangement pattern is not affected as long as n=t+s is satisfied, where t is the number of existing image slots included in the selected template in creation of the poster data, and s is the number of images added by the user.

### <Method of Calculating Evaluation Value of Image Arrangement Pattern>

In the present embodiment, the evaluation value C of each image arrangement pattern is calculated based on the following formula (1) that is a cost function.

$$C = {w}_{1} {S}_{1} + {w}_{2} {S}_{2} + {w}_{3} {S}_{3} \qquad Formula ( 1 )$$

In the formula (1), w₁ to w₃ are coefficients for adjusting weights of the respective terms.

S₁ is a sum of differences in hue histogram between the images used by the user before the template change and the images used after the template change (images arranged by default in the template selected by the user), and is calculated by the following formula (2).

$${S}_{1} = {\sum }_{i = 1}^{n} {H}_{i} , {H}_{i} = {\sum }_{j = 0}^{360} \vert {h}_{template , i , j} - {h}_{used , i , j} \vert \qquad Formula ( 2 )$$

In the case where the images used in the poster data before the template change are referred to as used image group, h_{u s e d, i ,j} is a histogram value of a hue j in an i-th image of the used image group. Moreover, h_{t e m p l a t e, i ,j} is a histogram value of a hue j in an image used by default in an image slot to which the i-th image of the used image group is assigned after the template change.

Considering S₁ enables evaluation of how much a shade of color of a target image arrangement pattern is similar to a shade of color of image arrangement in the selected template.

S₂ is a sum of differences in aspect ratios between the images (images used by the user before the template change) included in the used image group and the shapes of the image slots included in the template selected by the user, and is calculated by the following formula (3).

$${S}_{2} = {\sum }_{i = 1}^{n} {R}_{i} , {R}_{i} = \vert {r}_{template , i} - {r}_{used , i} \vert \qquad Formula ( 3 )$$

In the formula (3), r_{u s e d ,i} is a value of the aspect ratio in the i-th image of the used image group. Moreover, r_{t e m p l a t e ,i} is an aspect ratio of the image slot to which the i-th image of the used image group is assigned after the template change.

Considering S₂ enables evaluation of how much the original images can be displayed without cropping in the target image arrangement pattern.

S₃ is a sum of differences between the shapes of the image slots included in the poster data before the template change and the shapes of the image slots included in the poster data after the template change, and is calculated by the following formula.

$${S}_{3} = {\sum }_{i = 1}^{n} {P}_{i} , {P}_{i} = \vert {r}_{before , i} - {r}_{after , i} \vert + \vert {s}_{before , i} - {s}_{after , i} \vert \qquad Formula ( 4 )$$

In the formula (4), r_{b e f o r e, i} and s_{b e f o r e, i} are, respectively, values of the aspect ratio and the size of the image slot to which the i-th image of the used image group is assigned in the poster data before the template change.

In the formula (4), r_{a f t e r, i} and s_{a f t e r ,i} are, respectively, values of the aspect ratio and the size of the image slot to which the i-th image of the used image group is assigned in the poster data after the template change.

Considering S₃ enables evaluation of how much the shapes of the image slots to which the images are assigned in the target image arrangement pattern are similar to the shapes of the image slots in the poster data before the template change.

Note that, although the evaluation value is obtained by calculation of the above-mentioned cost functions in the present embodiment, for example, the evaluation value may be obtained by AI or the like using deep learning, or obtained by using functions other than the above-mentioned cost functions. Moreover, the above-mentioned evaluation value may be determined from one of the values of S₁ to S₃, or determined from, for example, two terms with S₁ to S₃.

As described above, according to the present embodiment, the usability in the layout data editing application can be improved. Specifically, it is possible to apply the image arrangement considering the intention of the user in the image arrangement originally performed by the user to the poster data after the template change while maintaining design properties of the template. Accordingly, the image arrangement of the poster data after the template change is more likely to be attractive to the user, and the user operation of adjusting display of the images can be reduced. Thus, changing of the template in a state where arbitrary images are arranged can be facilitated.

### Embodiment 2

In the present embodiment, explanation is given of a method of improving operability by allowing the user to select the image arrangement to be applied to the poster data after the template change.

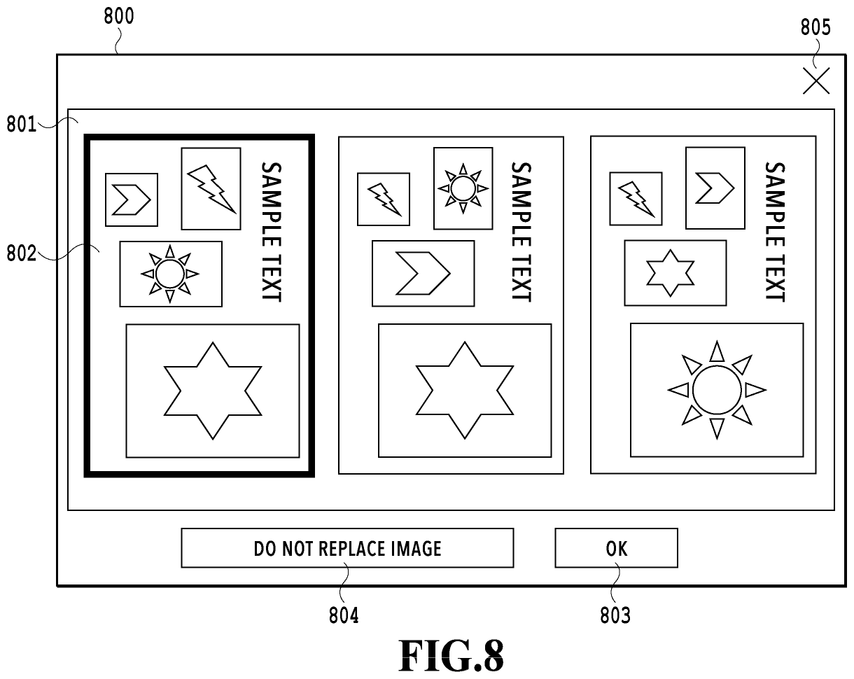

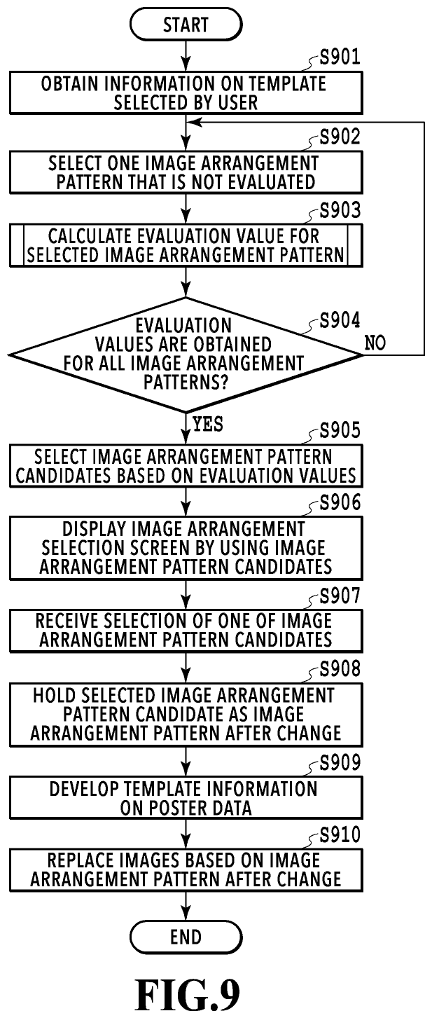

FIG. 8 is an example of screen displaying a result of generation of multiple image arrangements in response to selection of one of the templates 303 from the template selection region 302 by the user in the state where the poster data is being edited. The image arrangement selection screen 800 includes a poster data display region 801, poster data 802, an image arrangement determination button 803, a no-image-replacement button 804, and a close button 805. A predetermined number of pieces of poster data 802 are displayed in the poster data display region 801. In FIG. 8, three pieces of poster data are displayed in the poster data display region 801 as an example. The poster data 802 is poster data to which an image arrangement pattern candidate to be explained in FIG. 9 is applied. Pressing the image arrangement determination button 803 causes the poster producing application 202 to display the editing screen 300 by using the poster data 802 selected in the poster data display region 801. The poster data 802 can be subsequently edited in the editing screen 300. Pressing the no-image-replacement button 804 causes the poster producing application 202 to display the editing screen 300 by using the selected template without replacement of the images. Pressing the close button 805 closes the image arrangement selection screen 800.

The present embodiment is explained by using the flowchart of FIG. 9. FIG. 9 is a processing flow of the poster producing application 202 operating on the OS 201, and the processes of the flowchart in FIG. 9 are started in the case where the user selects an arbitrary template 303 from the template selection region 302 while editing the poster data. Since the processes of S901 to S904 are equivalent to the processes of S701 to S704 in FIG. 7, respectively, explanation thereof is omitted.

In S905, the poster producing application 202 selects the image arrangement patterns to be image arrangement pattern candidates in the possible image arrangement patterns, based on the evaluation values obtained in S902 to S904. A method of selecting the image arrangement pattern candidates is, for example, selection in a method in which a predetermined number of image arrangement pattern candidates are sequentially selected in the ascending order of evaluation value. Moreover, as another form, a method in which a predetermined value is determined as a threshold and the image arrangement patterns with the evaluation value equal to or smaller than the determined threshold are selected may be adopted.

In S906, the poster producing application 202 displays the poster data to which the image arrangement patterns selected as the image arrangement pattern candidates are applied, on the image arrangement selection screen. Specifically, the screen illustrated in FIG. 8 is displayed. The user can select the image arrangement pattern candidates displayed as described above.

In S907, the poster producing application 202 receives selection of one image arrangement pattern from the displayed image arrangement pattern candidates by the user.

In S908, the poster producing application 202 holds the image arrangement pattern selected by the user as the image arrangement pattern after the change. Note that, in the case where the user presses the no-image-replacement button 804 in the image arrangement selection screen displayed in S906, the image arrangement pattern with the smallest evaluation value is held as the image arrangement pattern after the change. Since processes equivalent to the processes of S706 to S707 in FIG. 7 are performed in S909 to S910, respectively, explanation thereof is omitted. After execution of S910, the poster producing application 202 terminates the processing flow of the present flowchart.

According to the present embodiment, the image arrangement pattern further matching the intention of the user can be applied to the poster data after the template change. This can reduce the user operation of adjusting the display of images, and improve the operability for the user.

### Other Embodiments

Although the case where the poster data is produced and edited is explained above, the embodiments can be applied also to the case where layout data other than the poster data is produced and edited.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-136358, filed Aug. 24, 2023, which is hereby incorporated by reference wherein in its entirety.

What is claimed is:

1. An information processing apparatus, comprising at least one memory and at least one processor and/or at least one circuit which function as:
an editing unit configured to edit layout data including at least one image slot in which an image is arranged;
a reception unit configured to receive an operation of selecting a template including at least one image slot in which an image is arranged, during editing of the layout data;
an obtaining unit configured to obtain template information of the selected template; and
a determination unit configured to determine an image to be arranged in the image slot included in the selected template, from the image arranged in the currently-edited layout data, based on predetermined information relating to the currently-edited layout data and the template information.

2. The information processing apparatus according to claim 1, wherein the determination unit determines an evaluation value that is the predetermined information, based on the currently-edited layout data and the selected template information, and determines the image to be arranged in the image slot included in the selected template from the image arranged in the currently-edited layout data, based on the evaluation value.

3. The information processing apparatus according to claim 2, wherein the evaluation value is determined from a hue histogram between the image arranged in the currently-edited layout data and the image arranged by default in the selected template.

4. The information processing apparatus according to claim 2, wherein the evaluation value is determined from aspect ratios of the image arranged in the currently-edited layout data and a shape of the image slot included in the selected template.

5. The information processing apparatus according to claim 2, wherein the evaluation value is determined from a shape of the image slot included in the currently-edited layout data and a shape of the image slot included in the selected template.

6. The information processing apparatus according to claim 2, wherein the determination unit determines the evaluation value for each of image arrangement patterns, and determines the image to be arranged in the template based on the image arrangement pattern with the smallest evaluation value.

7. The information processing apparatus according to claim 6, wherein, in the case where the number of images arranged by default in the selected template is smaller than the number of images arranged in the currently-edited layout data, the determination unit uses the images that achieve the image arrangement pattern with the smallest evaluation value from among the images arranged in the currently-edited layout data, as the images to be arranged in the selected template.

8. The information processing apparatus according to claim 6, wherein, in the case where the number of images arranged by default in the selected template is larger than the number of images arranged in the currently-edited layout data, the determination unit selects the image slots in which the images are to be arranged in the selected template such that the number of the selected image slots is equal to the number of images arranged in the currently-edited layout data.

9. The information processing apparatus according to claim 8, wherein the image slots selected by the determination unit are the image slots in the case where the image arrangement pattern with the smallest evaluation value is achieved.

10. The information processing apparatus according to claim 6, wherein, in the case where the user additionally arranges an image in the currently-edited layout data in addition to the image arranged by default in the currently-edited layout data, the determination unit adds the image arrangement pattern including the added image as a candidate of the image arrangement pattern for which the evaluation value is to be determined.

11. The information processing apparatus according to claim 1, wherein the determination unit displays a predetermined number of image arrangement patterns on a display unit included in the information processing apparatus, and determines an image to be newly arranged in the template based on the image arrangement pattern selected by the user.

12. The information processing apparatus according to claim 11, wherein the determination unit determines an evaluation value based on the currently-edited layout data and the selected template information, and displays as many image arrangement patterns as the predetermined number sequentially in the ascending order of the evaluation value, on the display unit.

13. The information processing apparatus according to claim 11, wherein the determination unit determines the evaluation value based on the currently-edited layout data and the selected template information, and displays the image arrangement patterns with the evaluation values smaller than a predetermined threshold, on the display unit.

14. The information processing apparatus according to claim 1, wherein the template information is information on the image arranged by default or a shape of the image slot in the template.

15. A non-transitory computer readable storage medium storing a program which functions in an information processing apparatus and causes the information processing apparatus to function as:
an editing unit configured to edit layout data including at least one image slot in which an image is arranged;
a reception unit configured to receive an operation of selecting a template including at least one image slot in which an image is arranged, during editing of the layout data;
an obtaining unit configured to obtain template information of the selected template; and
a determination unit configured to determine an image to be arranged in the image slot included in the selected template, from the image arranged in the currently-edited layout data, based on predetermined information relating to the currently-edited layout data and the template information.

16. A method of controlling an information processing apparatus, comprising:
editing layout data including at least one image slot in which an image is arranged;
receiving an operation of selecting a template including at least one image slot in which an image is arranged, during editing of the layout data;
obtaining template information of the selected template; and
determining an image to be arranged in the image slot included in the selected template, from the image arranged in the currently-edited layout data, based on predetermined information relating to the currently-edited layout data and the template information.
